(19) United States
(12) Patent Application Publication
(10) Pub. No.: US 2025/0058769 A1
(43) Pub. Date: Feb. 20, 2025

(54) Method and Device for Performing a Driving Maneuver

(71) Applicant: Bayerische Motoren Werke Aktiengesellschaft, Muenchen (DE)

(72) Inventors: Daniel TELSCHOW, Muenchen (DE); Benjamin Krimmer, Muenchen (DE); Rebecca Pascal, Muenchen (DE)

(21) Appl. No.: 18/806,833

(22) Filed: Aug. 16, 2024

(30) Foreign Application Priority Data
Aug. 18, 2023 (DE) 10 2023 122 190.6

(51) Int. Cl. B60W 30/06; G06V 20/58

(52) U.S. Cl. CPC B60W 30/06; G06V 20/586

(57) ABSTRACT

A device for performing a parking maneuver of a vehicle is configured to guide the vehicle with automated longitudinal and/or lateral guidance along a previously recorded trajectory when performing a previously recorded driving maneuver. The device is further configured to detect a parking space for the vehicle while performing the previously recorded driving maneuver, and, in response to the detection of the parking space, to cause a change from performing the previously recorded driving maneuver to performing a parking maneuver into the detected parking space.

### CROSS REFERENCE TO RELATED APPLICATION

This application claims priority under 35 U.S.C. § 119 from German Patent Application No. DE 10 2023 122 190.6, filed Aug. 18, 2023, the entire disclosure of which is herein expressly incorporated by reference.

### BACKGROUND AND SUMMARY

The disclosure relates to a method and a corresponding device which are configured to assist the user of a vehicle when parking the vehicle in a parking space.

A vehicle may have an assistance system that allows the user of the vehicle to record and store a driving trajectory driven during manual driving operation. The driving trajectory may relate to a parking maneuver of the vehicle, during which the vehicle is driven to a parking space (in particular a perpendicular or parallel parking space). The recorded and stored driving trajectory can be used at a later time to automatically guide the vehicle to the same parking space along the stored driving trajectory. This can increase the comfort of the vehicle in terms of the repeated performance of parking maneuvers.

It is possible that the parking space of a previously recorded parking maneuver is occupied at the time of the repeated performance of the parking maneuver. This typically results in a discontinuation of the repeated performance of the parking maneuver and thus in an impairment in the comfort for the user of the vehicle.

The disclosure generally relates to the technical object of increasing the comfort of a vehicle user when repeatedly performing recorded driving maneuvers, in particular parking maneuvers.

The object is achieved by at least each of the independent claims. Advantageous embodiments are described inter alia in the dependent claims. It is pointed out that additional features of a patent claim dependent on an independent patent claim, without the features of the independent patent claim or in combination only with a subset of the features of the independent patent claim, may form a standalone invention that is independent of the combination of all of the features of the independent patent claim and may be made into the subject matter of an independent claim, a divisional application or a subsequent application. This applies in the same way to technical teachings that are described in the description and may form an invention independent of the features of the independent patent claims.

One aspect describes a device for performing a driving maneuver, in particular a parking maneuver, of a (motor) vehicle. The device may be part of a driver assistance system for repeatedly performing driving maneuvers. The driving maneuver can be aimed at guiding the vehicle into a specific parking space.

The device may be configured to record, in a recording mode (of the driver assistance system), a trajectory driven by the vehicle when performing a driving maneuver, in order to determine a recorded trajectory (and to store it in a storage unit of the vehicle). In this case, in the recording mode, the longitudinal and/or (in particular and) the lateral guidance of the vehicle can be effected manually by the driver of the vehicle when performing the driving maneuver.

Trajectory data can be captured and recorded when recording the driving trajectory. The trajectory data can respectively specify, for a multiplicity of points and/or positions along the driving trajectory (starting from a starting position to an end position of the trajectory, and with a certain spatial resolution, e.g. at least 1 point and/or position per 10 cm or per 50 cm or per meter): the coordinates of the respective position; the orientation and/or alignment of the vehicle at the respective position; and/or the driving speed of the vehicle at the respective position.

The trajectory data relating to the driving trajectory can be stored in the storage unit of the vehicle. Furthermore, the trajectory data can be used in a replay mode (of the driver assistance system) to guide the vehicle automatically (with automated longitudinal and/or, in particular and, lateral guidance) along the previously recorded driving trajectory (from the starting position to the end position of the driving trajectory). The end position of the driving trajectory can be located in a parking space for the vehicle. The starting position can be located at the entrance to a parking region (e.g. a parking garage or a parking area).

The device is configured to guide the vehicle with automated longitudinal and/or (in particular and) lateral guidance along the previously recorded trajectory when performing the previously recorded driving maneuver.

For example, it can be detected (e.g. based on the current position of the vehicle, which can be determined by means of a GNSS (global navigation satellite system) sensor of the vehicle) that the vehicle is located at or in a defined environment of the starting position of the previously recorded driving maneuver. An offer to perform the previously recorded driving maneuver can then be output to the user of the vehicle (e.g. via a user interface of the vehicle), if appropriate in response to the detection. Furthermore, in response to a user input by the user (with regard to the offer output), it is possible to cause the previously recorded driving maneuver to be performed. Thus, a replay of the previously recorded driving maneuver can be effected.

The device is also configured to detect a (possibly different or alternative) parking space for the vehicle while performing the previously recorded driving maneuver (i.e. during the replay). It is possible to search for a suitable parking space for the vehicle, for example on the basis of environmental data (i.e. sensor data) from one or more environmental sensors of the vehicle (e.g. based on the camera data from at least one camera). In particular, it is possible to search for (and detect) a parking space which is in the environment of (e.g., beside) the previously recorded trajectory. Furthermore, it is possible to search for (and detect) a parking space that has a sufficiently large spatial extent (e.g. length and/or width) for the vehicle (such that the vehicle can be guided into the parking space (automatically)).

Furthermore, the device configured, in response to the detection of the parking space, to cause a change from performing the previously recorded driving maneuver to performing a parking maneuver into the detected parking space.

In particular, in response to the detection of the parking space, it is possible to cause an offer to perform the parking maneuver into the detected parking space to be output to the user of the vehicle (the offer can be output, for example, via the user interface of the vehicle). Furthermore, it is possible to cause a change from performing the previously recorded driving maneuver to performing the parking maneuver into the detected parking space if the user accepts the offer. On the other hand, it is possible to cause the performance of the previously recorded driving maneuver to be continued if the user does not accept the offer.

It is therefore possible to search for an alternative parking space for the vehicle during the replay of a previously recorded driving maneuver, and to allow the user of the vehicle to initiate an automated parking maneuver into the alternative parking space (and thereby to effect a smooth transition from the recorded driving maneuver to the parking maneuver). This makes it possible to further increase the comfort for the user of the vehicle. In particular, this can reduce the likelihood of the vehicle not being automatically guided to a parking space (because the parking space of the previously recorded driving maneuver is occupied). This is particularly advantageous during driving maneuvers in a public parking region.

The device may be configured to detect a user input (on the user interface) indicating that the user accepts the offer to perform the parking maneuver (into the detected parking space). In response to the detected user input, it may be possible to cause the vehicle to be automatically decelerated to a standstill at an intermediate position located on the previously recorded trajectory. Furthermore, it is possible to cause the vehicle to be guided to the detected parking space with automated longitudinal and/or (in particular and) lateral guidance starting from the intermediate position when performing the parking maneuver.

Alternatively or additionally, the device may be configured to detect a user input indicating that the user accepts the offer after the vehicle has been manually decelerated to a standstill (by the driver of the vehicle) at an intermediate position. In response to the detected user input, it is possible to cause the vehicle to be guided to the detected parking space with automated longitudinal and/or (in particular and) lateral guidance starting from the intermediate position when performing the parking maneuver.

This makes it possible to achieve a particularly comfortable transition between performing the previously recorded driving maneuver and the parking maneuver (into the detected parking space).

As already explained further above, the device may be configured to detect the parking space for the vehicle on the basis of environmental data from one or more environmental sensors of the vehicle. Furthermore, the device may be configured to determine a parking maneuver trajectory for the parking maneuver into the detected parking space on the basis of environmental data from one or more environmental sensors of the vehicle (wherein the parking maneuver trajectory extends from the intermediate position (at which the previously recorded driving maneuver is discontinued) to a parking end position in the detected parking space). The vehicle can be guided with automated longitudinal and/or (in particular and) lateral guidance along the determined parking maneuver trajectory when performing the parking maneuver.

The device may be configured to check whether the previously recorded trajectory leads to a parking space located in a (possibly public) parking region, in particular in a parking area or in a parking garage, with a multiplicity of different parking spaces. This can be determined, for example, on the basis of the GNSS coordinates of the end position of the recorded trajectory and/or on the basis of a digital map for the road network used by the vehicle.

It is possible to search for a parking space for the vehicle while performing the previously recorded driving maneuver if, in particular only if, the previously recorded trajectory leads to a parking space that is located in a (possibly public) parking region with a multiplicity of different parking spaces (e.g. with 3 or more, or 5 or more, or 10 or more parking spaces).

The search for an (alternative) parking space may therefore possibly be limited to situations where the previously recorded driving maneuver is located in a (possibly public) parking region (and where there is therefore a relatively high risk of the original parking space of the previously recorded driving maneuver being occupied). If, alternatively, it is detected that the parking space of the previously recorded driving maneuver is not located in a (possibly public) parking region with a multiplicity of parking spaces, and/or that the parking space of the previously recorded driving maneuver is located on private property, the search for an alternative parking space may possibly be prevented. This makes it possible to further increase the comfort for the user of the vehicle.

Another aspect describes a (road) motor vehicle (in particular a passenger vehicle or a commercial vehicle or a bus or a motorcycle) that comprises the device described in this document.

Another aspect describes a method for performing a driving maneuver, in particular a parking maneuver, of a vehicle. The method comprises guiding the vehicle with automated longitudinal and/or lateral guidance along a previously recorded trajectory when performing a previously recorded driving maneuver. The method further comprises detecting a parking space for the vehicle while performing the previously recorded driving maneuver. In addition, in response to the detection of the parking space, the method comprises causing a change from performing the previously recorded driving maneuver to performing a parking maneuver (with automated longitudinal and/or lateral guidance) into the detected parking space.

Another aspect describes a software (SW) program. The SW program may be configured to be executed on a processor (for example on a controller of a vehicle) and thereby to carry out the method described in this document.

Another aspect describes a storage medium. The storage medium may comprise an SW program that is configured to be executed on a processor and thereby to carry out the method described in this document.

It should be noted that the methods, devices and systems described in this document may be used both on their own and in combination with other methods, devices and systems described in this document. Furthermore, any aspects of the methods, devices and systems described in this document may be combined with one another in a wide variety of ways. The features of the claims may in particular be combined with one another in a wide variety of ways. Furthermore, features in parentheses are to be understood as optional features.

The invention is described in more detail below with reference to exemplary embodiments. Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows exemplary components of a vehicle;

FIG. 2a shows an exemplary recorded driving trajectory for a driving maneuver, in particular for a parking maneuver;

FIG. 2b shows an exemplary output with respect to a detected, alternative, parking space;

FIG. 2c shows an exemplary parking maneuver driving trajectory for a parking maneuver into the alternative parking space; and

FIG. 3 shows a flowchart of an exemplary method for performing a driving maneuver, in particular a parking maneuver.

### DETAILED DESCRIPTION OF THE DRAWINGS

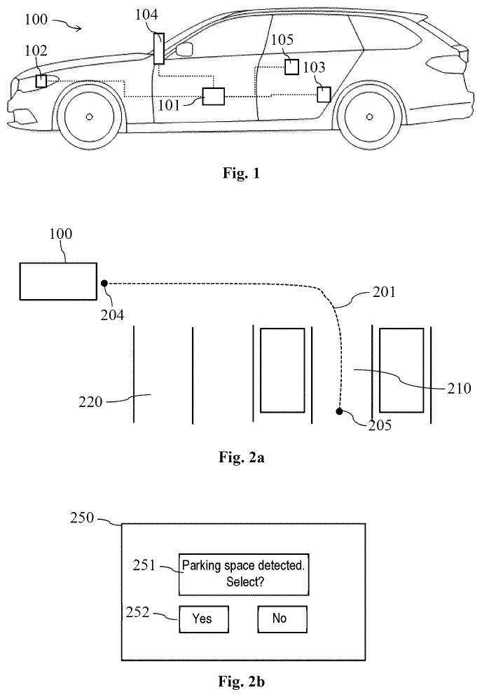

The disclosure relates generally to increasing the comfort for a user of a vehicle when performing a driving maneuver, in particular a parking maneuver. FIG. 1 shows an exemplary vehicle 100 having one or more environmental sensors 102 (for example at least one camera, at least one radar sensor, at least one lidar sensor, at least one ultrasound sensor, etc.) which are each configured to capture environmental data (i.e. sensor data) relating to the environment of the vehicle 100. A control device 101 of the vehicle 100 can be configured to evaluate the environmental data, in order to detect one or more objects in the environment of the vehicle 100.

The device 101 may also be configured to operate one or more longitudinal and/or lateral guidance actuators 103 of the vehicle 100 (for example a drive motor, a brake device and/or a steering device) in order to automatically longitudinally and/or laterally guide the vehicle 100. The one or more actuators 103 can be operated on the basis of the environmental data, in particular on the basis of the one or more detected objects.

The vehicle 100 may also comprise a user interface 104, which enables interaction between the user and the vehicle 100, for example in order to activate or deactivate a driver assistance function and/or to inform the user about the status of a driver assistance function. The user interface 104 may comprise one or more operating elements and/or one or more output elements (for example a screen).

The vehicle 100 may have a driver assistance system which is designed to record a driving trajectory driven by the vehicle 100. The driving trajectory can be driven manually by the driver of the vehicle 100 and/or automatically by the vehicle 100. Trajectory data relating to the driving trajectory can be stored in a storage unit 105 of the vehicle 100. The trajectory data can be determined on the basis of the sensor data from one or more sensors 102 of the vehicle 100. The trajectory data can respectively specify, for a multiplicity of positions (i.e. points) along the trajectory: (a) coordinates of the respective position (e.g. relative to a world coordinate system and/or relative to a coordinate system of the vehicle 100), which can be determined e.g. by means of a GNSS sensor of the vehicle 100; (b) the orientation and/or alignment of the vehicle 100 at the respective position; and/or (c) the driving speed of the vehicle 100 at the respective position.

The user of the vehicle 100 can explicitly start and/or stop the recording of a driving trajectory (using the user interface 104). This allows the starting position and/or the end position of the stored driving trajectory to be defined in a precise manner.

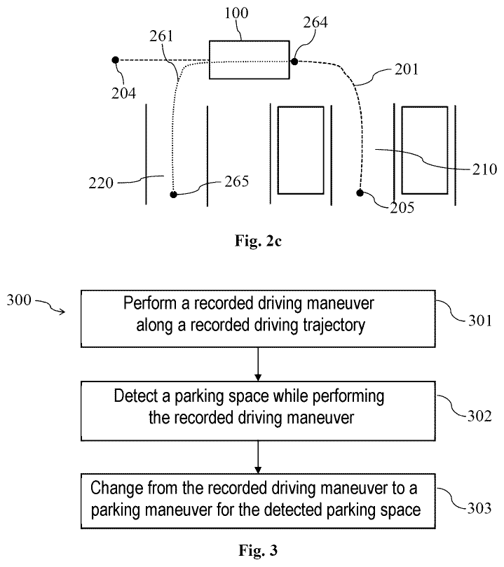

FIG. 2a shows an exemplary driving situation in which the vehicle 100 is driven to a parking space 210 along a driving trajectory 201, wherein the parking space 210 is located, for example, between two marking lines (generally markings). The driver of the vehicle 100 can start the recording of the driving trajectory 201 at the starting position 204 (for example by actuating an operating element of the user interface 104). The driver can manually longitudinally and/or laterally guide the vehicle 100 to an end position 205 in the parking space 210. The distance covered by the vehicle 100 between the starting position 204 and the end position 205 can be recorded as the driving trajectory 201 and can optionally be stored in the storage unit 105 of the vehicle 100. In particular, trajectory data relating to the driving trajectory 201 can be stored in the storage unit 105 of the vehicle 100.

The trajectory data can be used to perform the driving maneuver again, in particular the parking maneuver for parking the vehicle 100 in the parking space 210. For example, an offer to perform the driving maneuver again can be output to the driver of the vehicle 100 at or before reaching the starting position 204 via the user interface 104. The user can accept this offer (e.g. by actuating an operating element of the user interface 104). As a result, automated longitudinal and/or lateral guidance of the vehicle 100 is effected on the basis of the trajectory data, through which the vehicle 100 is guided along the previously recorded driving trajectory 201 to the end position 205 in the parking space 210.

The vehicle 100 may have, as a further driving function, a parking assistant which is configured to identify one or more parking spaces 220 suitable for the vehicle 100 in the environment of the vehicle 100, for example on the basis of the environmental data from the one or more environmental sensors 102 of the vehicle 100. For this purpose, a detected parking space 220 can be measured, and it can be checked whether the parking space 220 is sufficiently large (e.g. sufficiently long and/or sufficiently wide) for the vehicle 100. If the detected parking space 220 is suitable (in particular sufficiently large) for the vehicle 100, an offer to perform a parking maneuver into the detected parking space 220 can be output to the driver of the vehicle 100 via the user interface 104. The driver of the vehicle 100 can accept the offer (e.g. by actuating an operating element of the user interface 104). As a result, an automated parking maneuver (e.g. with automated longitudinal and/or lateral guidance) is effected by the vehicle 100 in order to guide the vehicle 100 to the parking space 220. In this context, a parking maneuver trajectory is determined by the control device 101 of the vehicle 100 (on the basis of the environmental data from the one or more environmental sensors 102), and the vehicle 100 is automatically guided to the detected parking space 220 along the parking maneuver trajectory.

It may be possible for the user of the vehicle 100 to use the parking assistant during the repeated performance of a previously recorded driving maneuver, in particular a parking maneuver. The parking assistant may possibly be activated as standard during the replay of a previously recorded driving maneuver. Alternatively or additionally, it can be possible for the user to activate the parking assistant via the user interface 104.

It can then be checked during the performance of the recorded driving maneuver, i.e. during the journey on the recorded driving trajectory 201 from the starting position 204 to the end position 205, whether there is at least one alternative parking space 220 (which differs from the parking space 210 of the recorded driving maneuver) that is suitable for the vehicle 100 in the environment of the vehicle 100.

If an alternative parking space 220 is detected, an offer to drive the vehicle 100 automatically to the alternative parking space 220 (and to discontinue the performance of the recorded driving maneuver) can be output to the user of the vehicle 100 (while performing the recorded driving maneuver) via the user interface 104. FIG. 2b shows an exemplary output 250 comprising the information 251 that an alternative parking space 220 has been detected, and comprising a query 252 as to whether or not an automated parking maneuver into the detected parking space 220 is to be carried out.

If the user chooses the automated parking maneuver into the alternative parking space 220, the ongoing performance of the recorded driving maneuver is discontinued and instead the vehicle 100 is automatically (longitudinally and/or laterally) guided to the alternative parking space 220 (without the need for any further action by the user of the vehicle 100). In this context, as illustrated by way of example in FIG. 2c, it is possible to determine a parking maneuver trajectory 261 which leads from an intermediate position 264 to a parking end position 265 in the alternative parking space 220. The parking maneuver trajectory 261 can be determined on the basis of environmental data from the one or more environmental sensors 102 of the vehicle 100. The intermediate position 264 may be located on the previously recorded trajectory 201.

As already explained further above, it may be the case, in particular in a parking garage or in a parking area without assigned parking spaces 210, that the parking end position 205 for the replay of a recorded driving maneuver is occupied. This can result in the replay of a previously recorded driving maneuver being discontinued before reaching the end position 205.

This document describes a driving function which, during an active replay of a previously recorded driving maneuver, checks possible parking spaces 220 (in particular parking spots) for the vehicle 100 (in particular with regard to the size of the respective parking space 220) and (if suitable for the vehicle 100) offers them via the user interface 104. The user can then change to the parking maneuver and park in another parking space 220.

In an exemplary configuration, the user can start the replay (i.e. the repeated performance) of a recorded driving maneuver, whereupon the vehicle 100 is guided with automated longitudinal and lateral guidance along a previously recorded driving trajectory 201. The recorded driving trajectory 201 may possibly lead past another parking spot 220. The (control) device 101 can then check whether or not the parking spot 220 is suitable for the vehicle 100, and an offer for an automated parking maneuver into the parking spot 220 can possibly be output (via the user interface 104).

The user of the vehicle 100 can then brake the vehicle 100 to a standstill and can accept the offer for the automated parking maneuver (when the vehicle 100 is stationary). Alternatively or additionally, it may be possible for the user to accept the offer while the vehicle 100 is moving. The vehicle 100 can then be braked automatically (to a standstill).

Starting from the standstill of the vehicle 100, an automatic change from the replay of the recorded driving maneuver to the automated parking maneuver can be effected. Automated longitudinal and lateral guidance of the vehicle 100 into the parking space 220 (detected and checked during the replay) is then carried out.

FIG. 3 shows a flowchart of a (possibly computer-implemented) method 300 for performing a driving maneuver, in particular a parking maneuver, of a (motor) vehicle 100. The method 300 comprises guiding 301 the vehicle 100 with automated longitudinal and/or lateral guidance (in particular with automated longitudinal and lateral guidance) along a previously recorded trajectory 201 when performing a previously recorded driving maneuver. The trajectory 201 may have been stored beforehand in a storage unit 105 of the vehicle 100, and can be read out for performance from the storage unit 105.

The method 300 further comprises detecting 302 a parking space 220 for the vehicle 100 while performing the previously recorded driving maneuver. The parking space 220 may be located along the previously recorded trajectory 201. The parking space can be detected on the basis of the environmental data from one or more environmental sensors 102 of the vehicle 100.

Furthermore, in response to the detection 302 of the parking space 220, the method 300 comprises causing 303 a change from performing the previously recorded driving maneuver to performing a parking maneuver into the detected parking space 220. For this purpose, a parking maneuver trajectory 261 can be determined, in particular calculated (e.g. on the basis of the environmental data from the one or more environmental sensors 102). The vehicle 100 can then be guided with automated longitudinal and/or (in particular and) lateral guidance to the detected parking space 220 along the parking maneuver trajectory 261.

The aspects described in this document make it possible to increase the comfort for a user in an efficient and reliable manner when performing a parking maneuver.

The present invention is not restricted to the exemplary embodiments that are shown. It should in particular be noted that the description and the figures are intended to illustrate the principle of the proposed methods, devices and systems only by way of example.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for performing a parking maneuver of a vehicle, comprising:
a vehicle controller configured to:
guide the vehicle with automated longitudinal and/or lateral guidance along a previously recorded trajectory when performing a previously recorded driving maneuver;
detect a parking space for the vehicle while performing the previously recorded driving maneuver; and
in response to the detection of the parking space, cause a change from performing the previously recorded driving maneuver to performing a parking maneuver into the detected parking space.

2. The device of claim 1, wherein the vehicle controller is further configured to:
in response to the detection of the parking space, cause an offer to perform the parking maneuver into the detected parking space to be output to a user of the vehicle;
cause a change from performing the previously recorded driving maneuver to performing the parking maneuver into the detected parking space if the user accepts the offer; and
continue to perform the previously recorded driving maneuver if the user does not accept the offer.

3. The device of claim 2, wherein the vehicle controller is further configured to:
detect a user input indicating that the user accepts the offer;
in response to the detected user input, cause the vehicle to be automatically decelerated to a standstill at an intermediate position located on the previously recorded trajectory; and
cause the vehicle to be guided to the detected parking space with automated longitudinal and/or lateral guidance starting from the intermediate position when performing the parking maneuver.

4. The device of claim 2, wherein the vehicle controller is further configured to:
detect a user input indicating that the user accepts the offer after the vehicle has been manually decelerated to a standstill at an intermediate position; and
in response to the detected user input, cause the vehicle to be guided to the detected parking space with automated longitudinal and/or lateral guidance starting from the intermediate position when performing the parking maneuver.

5. The device of claim 1, wherein the vehicle controller is further configured to:
detect the parking space for the vehicle on the basis of environmental data from one or more environmental sensors of the vehicle;
determine a parking maneuver trajectory for the parking maneuver into the detected parking space on the basis of environmental data from one or more environmental sensors of the vehicle; and
guide the vehicle with automated longitudinal and/or lateral guidance along the determined parking maneuver trajectory when performing the parking maneuver.

6. The device of claim 5, wherein the vehicle controller is further configured to:
determine an intermediate position that is on the previously recorded trajectory; and
determine a parking maneuver trajectory for the parking maneuver, which leads from the intermediate position to a parking end position in the detected parking space.

7. The device of claim 1, wherein the vehicle controller is further configured to:
detect a parking space on the basis of environmental data from one or more environmental sensors of the vehicle, wherein the parking space: is beside the previously recorded trajectory and/or has a sufficiently large spatial extent for the vehicle.

8. The device of claim 1, wherein the vehicle controller is further configured to
output an offer to perform the previously recorded driving maneuver to a user of the vehicle; and
in response to a user input by the user, cause the previously recorded driving maneuver to be performed.

9. The device of claim 8, wherein the vehicle controller is further configured to:
detect that the vehicle is located at or in a defined environment of a starting position of the previously recorded driving maneuver; and
output the offer to perform the previously recorded driving maneuver to the user of the vehicle in response to the detection.

10. The device of claim 1, wherein the vehicle controller is further configured to:
check whether the previously recorded trajectory leads to an original parking space located in a parking region, in particular in a parking area or in a parking garage, with a multiplicity of different parking spaces; and
search for a parking space for the vehicle when performing the previously recorded driving maneuver if, in particular only if, the previously recorded trajectory leads to an original parking space that is located in a parking region with a multiplicity of different parking spaces.

11. A method for performing a parking maneuver of a vehicle, comprising:
guiding the vehicle with automated longitudinal and/or lateral guidance along a previously recorded trajectory when performing a previously recorded driving maneuver;
detecting a parking space for the vehicle while performing the previously recorded driving maneuver; and
in response to the detection of the parking space, causing a change from performing the previously recorded driving maneuver to performing a parking maneuver into the detected parking space.
